(19) United States
(12) Patent Application Publication
(10) Pub. No.: US 2018/0022027 A1
(43) Pub. Date: Jan. 25, 2018

(54) Three Dimensional Full Color Printer with Multi-Input Nozzle

(71) Applicant: Mohawk Innovations Limited, Dublin (IE)

(72) Inventor: Jason J. Powell, East Rutherford, NJ (US)

(73) Assignee: Mohawk Innovations Limited, Dublin (IE)

(21) Appl. No.: 15/723,074

(22) Filed: Oct. 2, 2017

Related U.S. Application Data
(60) Provisional application No. 62/403,208, filed on Oct. 3, 2016.

(51) Int. Cl. B29C 64/209; B33Y 30/00; B29C 64/118

(52) U.S. Cl. CPC B29C 64/209; B29C 64/118; B33Y 30/00

(57) ABSTRACT

This invention teaches a nozzle assembly for a 3D FDM color printer for residential usage that is capable of printing multicolored 3D objects based on a users' input file. The nozzle assembly has at least two separate inputs for filament. Each filament can be liquefied by heating elements in a controlled manner and then mixed with other filaments in a mixing block portion of the nozzle to create a variety of colors for use in printing the 3D object. A closed loop water cooling system connected to the cooling block portion of the nozzle assembly prevents the filament from liquefying outside of the mixing block and clogging the nozzle assembly. In a preferred embodiment there are five filament inputs for the colors white, black, cyan, magenta, and yellow to cover the color spectrum.

### CROSS-REFERENCE TO RELATED APPLICATIONS

This application claims priority to U.S. Provisional Patent Application No. 62/403,208 filed on Oct. 3, 2016, entitled “Three Dimensional Full Color Printer with Multi-Input Nozzle,” the entire enclosure of which is incorporated herein by reference.

### FIELD OF THE INVENTION

This invention relates to the field of three dimensional (3D) printers. More specifically, the present invention relates to a nozzle assembly for a three dimensional fused deposition modeling (FDM) printer that can print 3D objects of any geometry in a variety of colors, hues, or mixtures of colors and/or materials. This invention is designed such that multiple filaments, of varying colors and/or opacities, can each have an input in a FDM printer nozzle and mix together in proscribed amounts to create desired color and/or opacity patterns for printing 3D objects. In addition, this invention is designed for residential usage and to be compatible with software wherein an individual can select objects to print and then customize with a variety of colors.

### BACKGROUND OF THE INVENTION

There are many types of 3D printers using additive manufacturing techniques in the marketplace. However, none address the long felt need of allowing a user to print a 3D object of any geometry, in any color palette or blend as well as mix and control the colors used in printing the 3D object.

This invention teaches a nozzle assembly system for a three dimensional FDM printer that allows for a plurality of input filaments, heats them to a molten state and mixes the various filament colors and/or materials to allow for an expansive palette of colors and/or materials to be used in printing each object giving a user greater freedom and creativity for prototyping and creating.

### SUMMARY OF THE INVENTION

The following is a non-limiting written description of embodiments illustrating various aspects of this invention. As used herein, the term filament is meant to describe an extruded material that can be change from the solid to the liquid or semi-liquid state when heat is applied to it. Many types of materials are known in the art for use as three dimensional printing filament, including but not limited to, polylactic acid (PLA), acrylonitrile butadiene styrene (ABS), nylon, polyethylene terephthalate (PET), and glycerol (PETG), polyvinyl alcohol (PVA), wax, polycarbonate (PC), and polypropylene (PP). In a preferred embodiment, PLA or PET filaments are utilized.

This invention teaches a 3D printer capable of printing objects of various geometries using a variety of colored filaments that can be melted together in a controlled manner to create new colors for use in printing 3D objects. This invention teaches a nozzle assembly with at least two separate inputs for filament. In a preferred embodiment, the nozzle assembly has five inputs for five separate filaments for printing.

Each filament is in solid state when it enters the cooling block portion of the nozzle. The filament begins to melt and becomes liquid or semi-solid towards the bottom portion of the cooling block as the filament is heated by heating elements that are connected to the mixing block. The liquefied filament then enters a cavity in the mixing block where it can be mixed with other liquefied filaments from other inputs. From the mixing block, the liquefied filament exits the nozzle to form a portion of the 3D object being printed.

In a preferred embodiment the heating elements are ceramic heating elements are powered by traditional power sources such as direct current (DC). The mixing block has orifices that the ceramic heating elements can be inserted into to heat the entire mixing block.

To prevent the liquefied filament from clogging the tube in the cooling block, a heat break separates the mixing block from the cooling block. In a preferred embodiment, the heat breaks, cooling blocks, and mixing block are all made from materials with different thermal coefficients. In another preferred embodiment, the mixing block is manufactured from brass or a material with properties similar to brass that has good thermal conductivity in that the brass will allow the filament in and near the brass to heat up and melt and will prevent the heat from dissipating and melting the filament in the cooling blocks or heat breaks. In a preferred embodiment, the heat breaks are made from steel and the cooling blocks made from aluminum to prevent the heat generated by the heating elements in the mixing block from melting the filament in the cooling blocks and preventing the filament from flowing through the nozzle without clogging.

To keep the filaments from liquefying in the cooling blocks and heat breaks, a closed loop water cooling system cycles through the cooling blocks, with water pumped and cycle around the nozzle system. In other preferred embodiments, the cooling system cycle can use other types of liquids and can be open loop.

Hollow tubes connect the cooling blocks to each other. In a preferred embodiment the hollow tubes are made out of a flexible plastic.

### BRIEF DESCRIPTION OF THE DRAWINGS

FIG. 1 shows an exploded view of the multi-input nozzle assembly.

FIG. 2 shows a side view of the multi-input nozzle assembly.

FIG. 3 shows a bottom view of the multi-input nozzle assembly.

FIG. 4 shows a top view of the multi-input nozzle assembly.

FIG. 5 shows a side wireframe view of the internal channels of the multi-input nozzle assembly.

FIG. 6 shows a perspective view of the multi-input nozzle assembly without the nozzle piece.

FIG. 7 shows a perspective view of a heat break for the multi-input nozzle assembly.

FIG. 8 shows a wireframe side view of the internal conduit of a heat break for the multi-input nozzle assembly.

FIG. 9 shows a side wireframe view of the internal conduits in the mixing block of the multi-input nozzle assembly.

FIG. 10 shows a top view of the mixing block of the multi-input nozzle assembly.

FIG. 11 shows a bottom view of the mixing block of the multi-input nozzle assembly.

FIG. 12 shows a perspective view of the mixing block of the multi-input nozzle assembly.

FIG. 13 shows a side view of the nozzle of the multi-input nozzle assembly.

FIG. 14 shows a top view of the nozzle of the multi-input nozzle assembly.

FIG. 15 shows a perspective wireframe view of the nozzle of the multi-input nozzle assembly.

FIG. 16 shows a perspective view of the nozzle of the multi-input nozzle assembly.

FIG. 17 shows a side wireframe view of a fitting for the cooling of the multi-input nozzle assembly.

FIG. 18 shows a perspective view of a fitting for the cooling of the multi-input nozzle assembly.

FIG. 19 shows a wireframe view of a fitting for the cooling of the multi-input nozzle assembly.

FIG. 20 shows a wireframe view of a fitting for the cooling of the multi-input nozzle assembly.

FIG. 21 shows a perspective view of a fitting for the cooling of the multi-input nozzle assembly.

FIG. 22 shows a wireframe perspective view of a fitting for the cooling of the multi-input nozzle assembly.

FIG. 23 shows a top view of the water block for the multi-input nozzle assembly.

FIG. 24 shows a side wireframe of the water block for the multi-input nozzle assembly.

FIG. 25 shows a perspective view of the water block for the multi-input nozzle assembly.

### DETAILED DESCRIPTION OF THE DRAWINGS

This invention is designed such that a three-dimensional FDM printer can have multiple input nozzles of varying colored filaments. In the present invention, there are five input nozzles wherein five different colors of filament can enter. However, in other conceivable embodiments there can be more or less inputs to allow for more or fewer number of filament types to be used for the FDM printing.

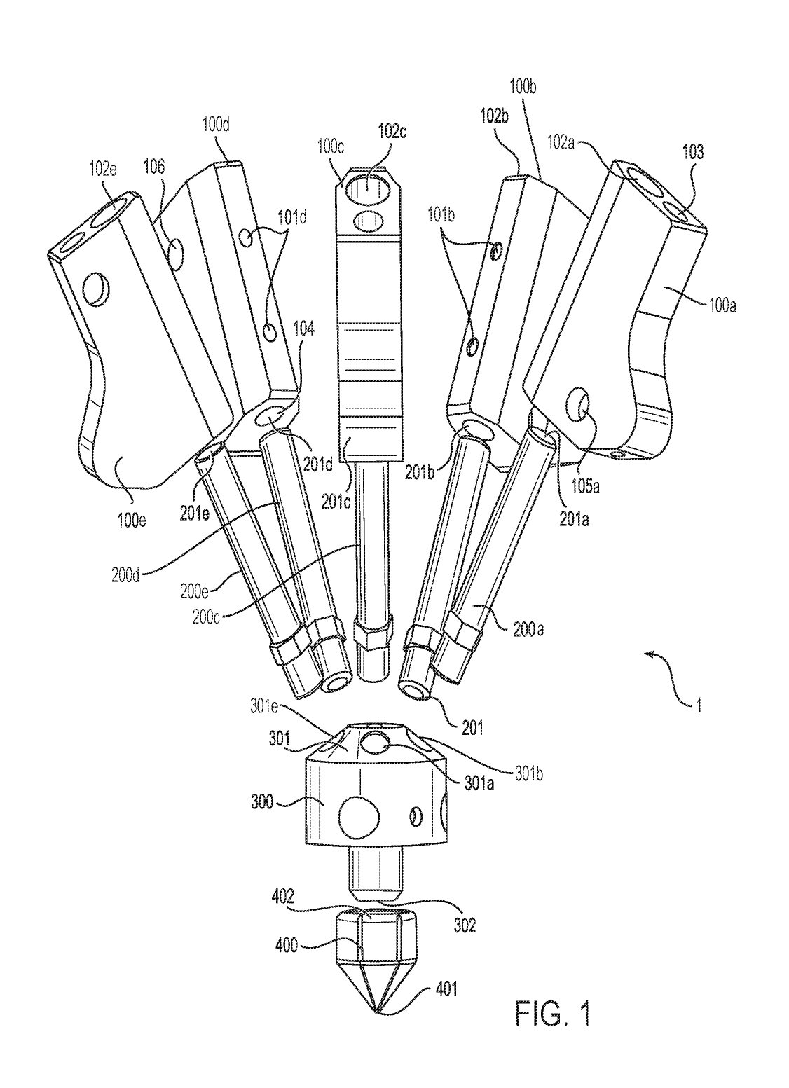

FIG. 1 shows an exploded view of a nozzle assembly 1 with multiple filament inputs for a 3D FDM printer (printer not shown). In the present embodiment, the nozzle assembly 1 has five separate orifices 102a, 102b, 102c, 102d, 102e, traversing the length of each cooling block 100a, 100b, 100c, 100d, 100e. Each cooling block 100a, 100b, 100c, 100d, 100e allows for a separate spool (not shown) of filament enter the nozzle assembly 1. The spools of filament can be housed in flexible tubes (not shown) to control the manner in which they are fed into the nozzle assembly 1.

A heat break 200a, 200b, 200c, 200d, 200e, each with an orifice traversing the length of each cooling block 100a, 100b, 100c, 100d, 100e is inserted in the first tube of each cooling block.

There is a first orifice 201a at a first (proximal) end of the heat break 200a, an orifice 201b is at a first (proximal) end of the heat break 200b, the orifice 201c is at first end of the heat break 200c, the orifice 201d is at one end of the heat break 200d, and the orifice 201e is at one end of the heat break 200e.

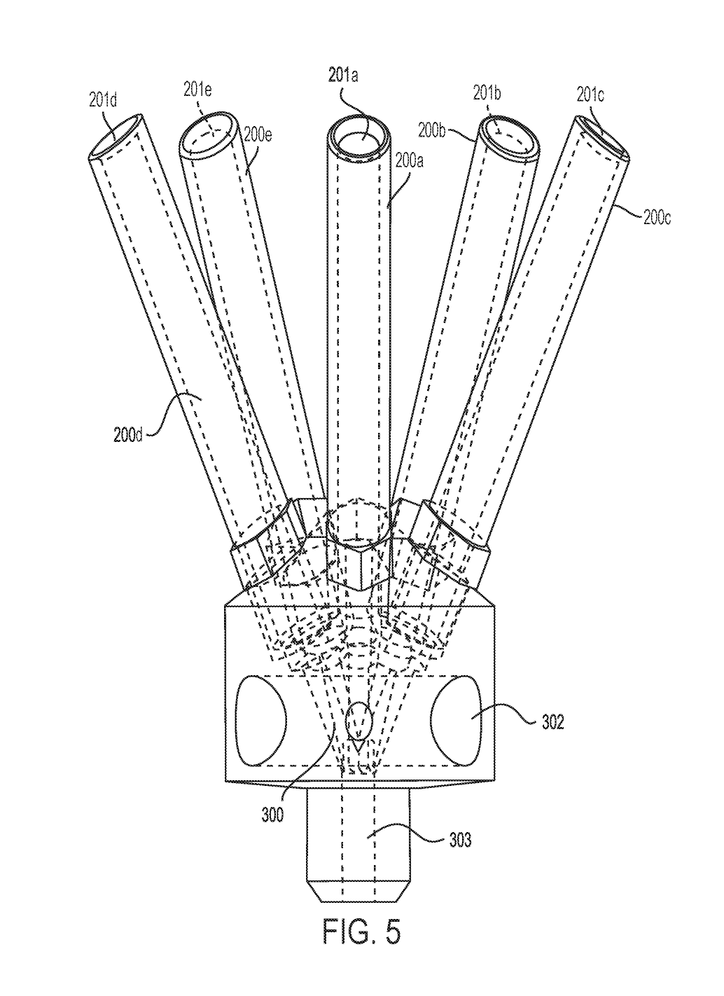

Cooling blocks 100a, 100b, 100c, 100d, 100e surround each of the heat breaks 200a, 200b, 200c, 200d, 200e. Each of the heat breaks 200a, 200b, 200c, 200d, 200e has a second orifice 202a, 202b, 202c, 202d, 202e that filament can exit from to enter the mixing block 300. The multiple filament inputs mix in the mixing block 300 cavity (see FIG. 5) and exit the mixing block 300 via orifice 302 to nozzle 400. In the mixing block 300 the filament is liquefied. The different filaments can mix in the mixing block cavity when they are liquefied. From the nozzle orifice 401, the molten filament exits the nozzle assembly 1 to create a piece of the desired 3D object.

The nozzle 400 has a first female end 402 that can connect to the male end of the mixing block 300. On the side opposite the nozzle female end 402 is a nozzle orifice 401 that the mixed molten filament can exit the nozzle assembly 1 from.

The mixing block 300 has top facet 301 with five orifices 301a, 301b, 301c, 301d, 301e wherein each of the five heat breaks 200a, 200b, 200c, 200d, 200e can be inserted via a male-female coupling, snapped together, and/or threaded. Each heat break 200a, 200b, 200c, 200d, 200e is surrounded by a cooling block 100a, 100b, 100c, 100d, 100e. Each heat break 200a, 200b, 200c, 200d, 200e traverses the length of each cooling block 100a, 100b, 100c, 100d, 100e, via first and second orifices 102a, 104a, 102b, 104b, 102c, 104c, 102d, 104d, 102e, 104e, respectively.

The molten filament enters the heat break at 102 upon entering the nozzle assembly 1 (filament not shown). Each cooling block 100 has a separate conduit (outlet at 103) wherein a cooling liquid (preferably water) can cycle through the cooling block 100 to prevent the filament from becoming stuck or expanding too much in the heat break 200. The cooling liquid can enter each cooling block 100 via an inlet at 106 and exit at outlet 105. A conduit containing cooling liquid can attach at one cooling block's outlet 105 to another cooling block's inlet 106 so the same cooling liquid system can be used throughout the entire nozzle assembly 1. The cooling block 100 is held in place on the heat break 200 using set screws 101.

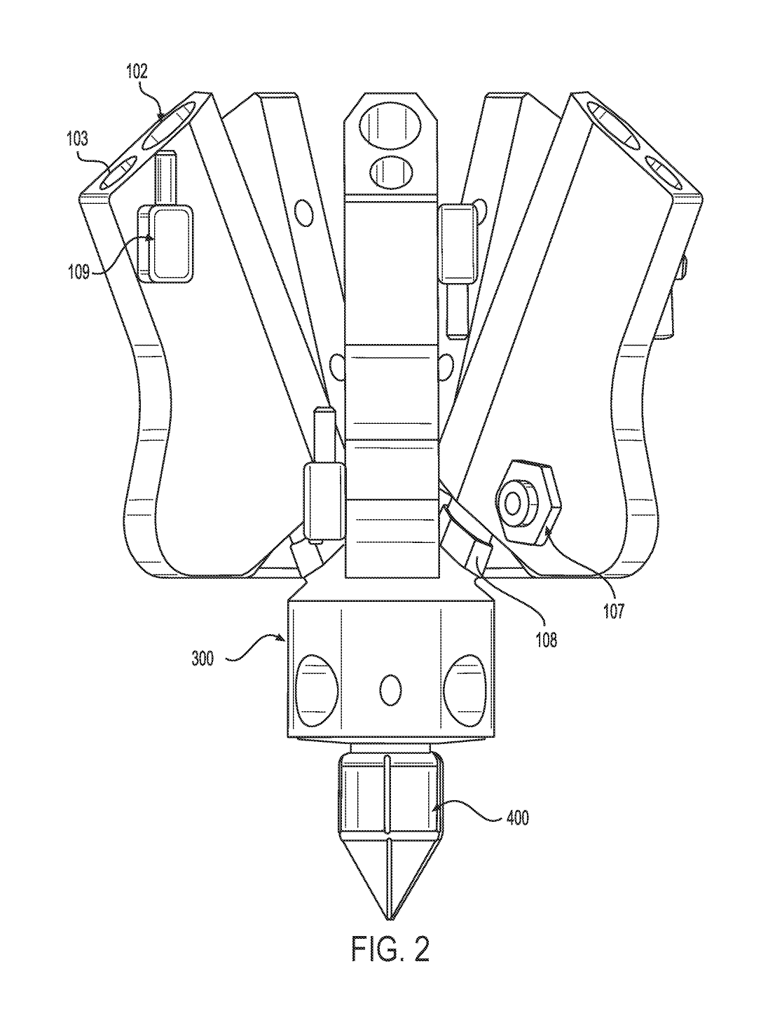

FIG. 2 shows a side view of the nozzle assembly. In the present embodiment there are five cooling blocks 100. Each cooling block 100 has a conduit 102 wherein filament can enter and a separate conduit 103 wherein the cooling liquid passes through. A pneumatic pump 109 attached to the cooling block 100 is used to pump the liquid coolant around the five cooling blocks to prevent filament from expanding and/or becoming stuck in the conduit 102 of the cooling block 100. Liquid coolant exits out of one cooling block 100 through the fitting 107 and into the next cooling block 100 at pneumatic pump 109. A tube (not shown) connects the cooling liquid from the fitting 107 on one cooling block to the pneumatic pump 109 on another cooling block.

Each heat break 200 is securely attached to the mixing block 300 with a washer 108.

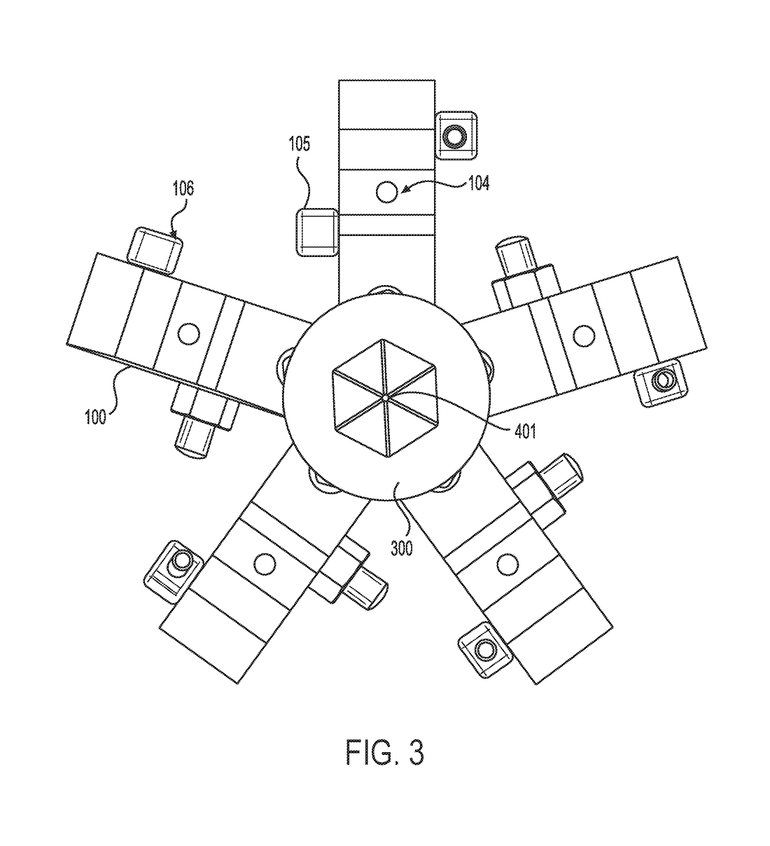

FIG. 3 is a bottom view of the nozzle assembly. Molten filament that has been mixed from the variety of colored filaments exits the nozzle assembly at the nozzle exit 401. From the nozzle exit 401 the molten filament enters the printing bed (not shown) to create three dimensional FDM printed objects (not shown). The nozzle exit 401 is at the end of the nozzle 400. The nozzle 400 is connected to the mixing block 300. The heat breaks are attached to the mixing block and each heat break has a conduit wherein filament can flow. The cooling block 100 fully surrounds each heat break and a cooling liquid system entering each cooling block at 105 and exiting each cooling block at 106 cools each heat break and prevents the filament from expanding too much and becoming clogged in the heat break.

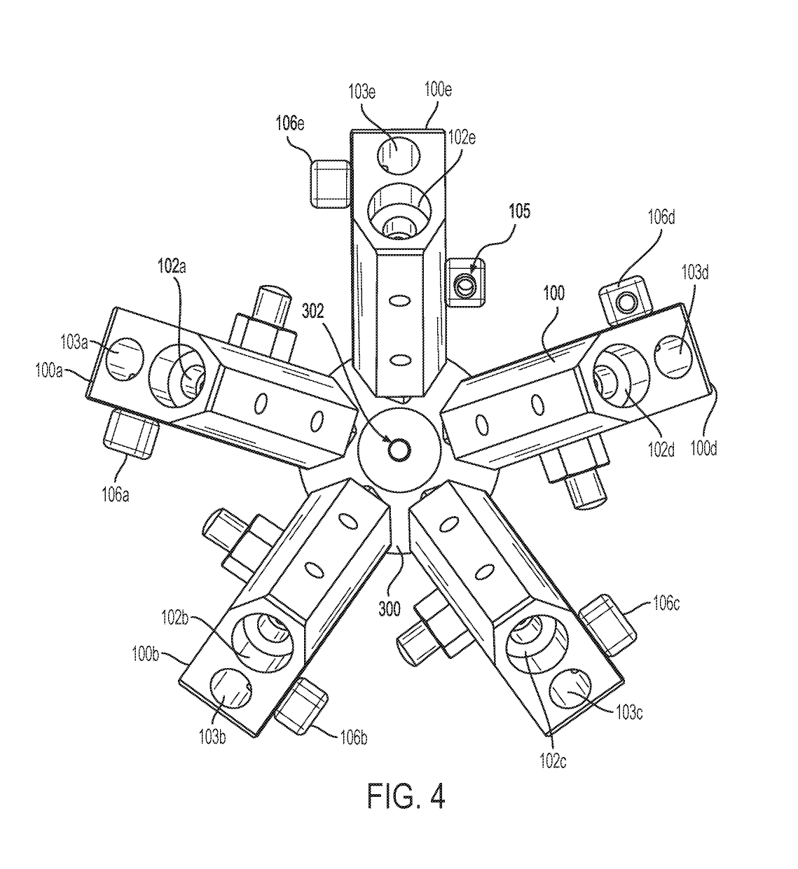

FIG. 4 shows a top view of the nozzle assembly. There are five cooling blocks 100. Each cooling block 100 has a conduit 102 that fully surrounds each heat break. The molten filament (not shown) passes through the heat break conduit inside the cooling block 100. The liquid cooling system enters each cooling block 100 via a conduit at 105 and exits each cooling block 100 via an outlet with a pneumatic pump 106. Tubes (not shown) connect the outlet 106 of one cooling block 100 with the inlet 105 of another cooling block 100.

The mixing block 300 has an inlet 302 wherein an electric source for the heating element and/or control for the amount and color of filament to pass is contained.

FIG. 5 shows a wireframe view of all of the interior conduits in the nozzle assembly 1 system. Each heat break 200 has a conduit 201 wherein filament passes through. All of the filament can merge in a cavity in the mixing block 300. The filament is heat and mixed in the mixing block 300 and can exit out of the conduit 303 and into the nozzle (not shown) for printing. Heaters (not shown) are connected to the mixing block 300 at 302 to melt the filament to a state wherein multiple colors can be mixed for varying effects.

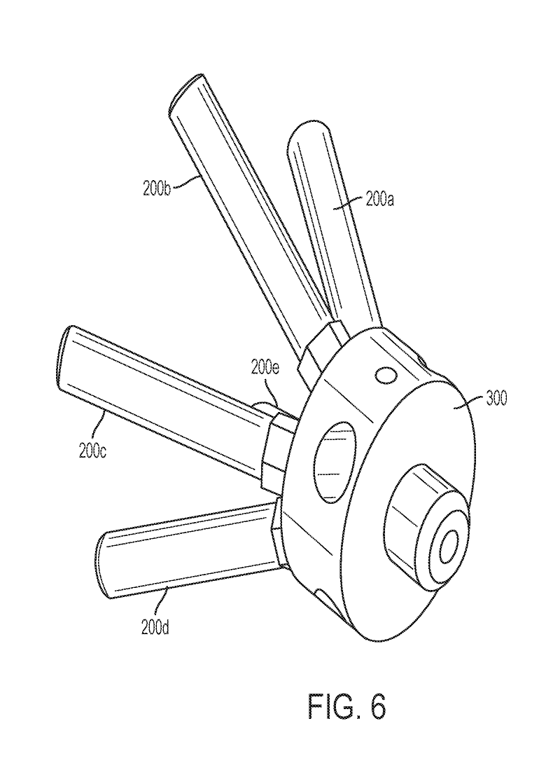

FIG. 6 shows a perspective view of the mixing block 300 with the five heat breaks 200 attached at the top facet of the mixing block 300.

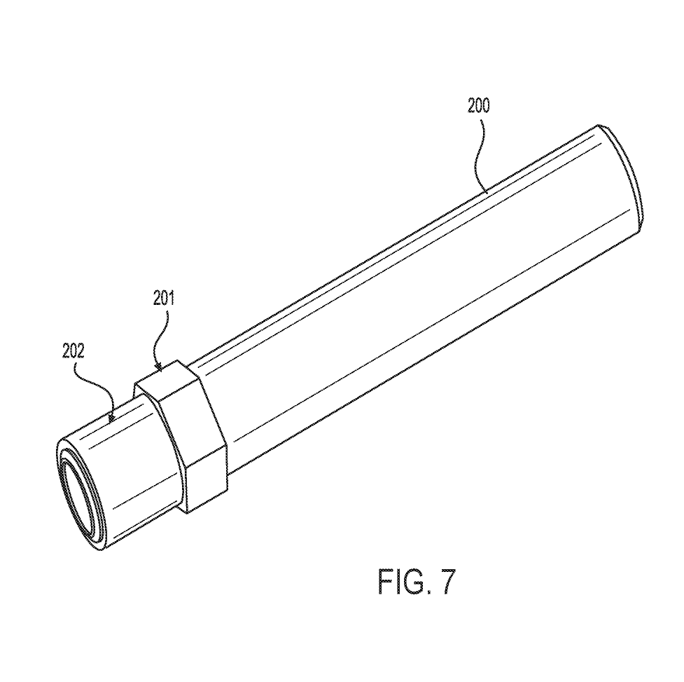

FIG. 7 shows a side view of one of the heat breaks 200 with a collar 201 and lower portion 202 that is inserted into the mixing block (not shown).

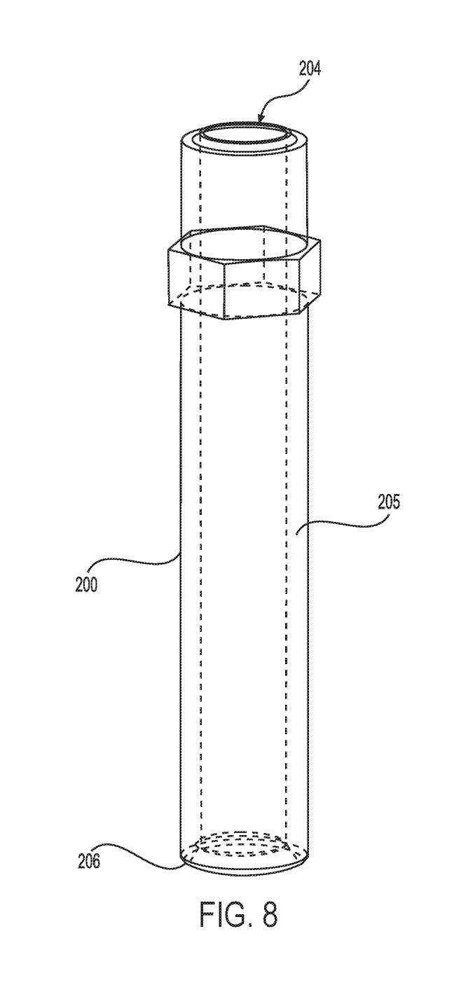

FIG. 8 shows a wireframe view of the heat break 200. The outlet 204 connects to the mixing block (not shown), filament passes through the conduit 205 and enters at the inlet 206.

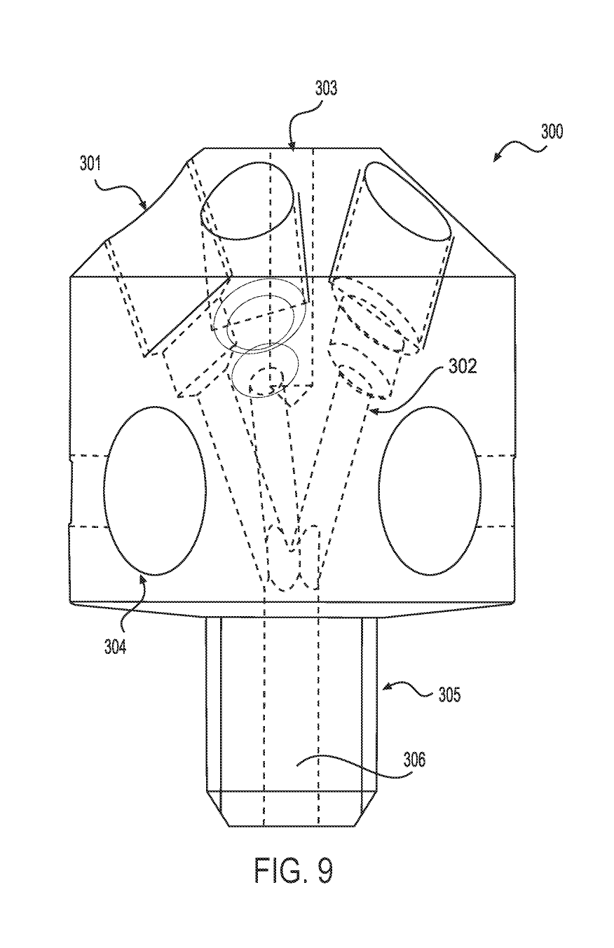

FIG. 9 shows the mixing block 300 with a plurality of orifices 301 wherein the heat breaks (not shown) connect to the mixing block 300. Interior conduits 302 connect the plurality of filaments together in the mixing block 300 to create various color mixing effects based on the primary colors of the filament. Heaters (not shown) connect to the mixing block 300 at 304 and 303 and heat the filament in the mixing block 300. Molten filament exits the mixing block 300 via a conduit 306 contained in male sleeve 305. The male sleeve 305 is inserted and connect to the nozzle (not shown) wherein the molten filament exits to create FDM colored objects.

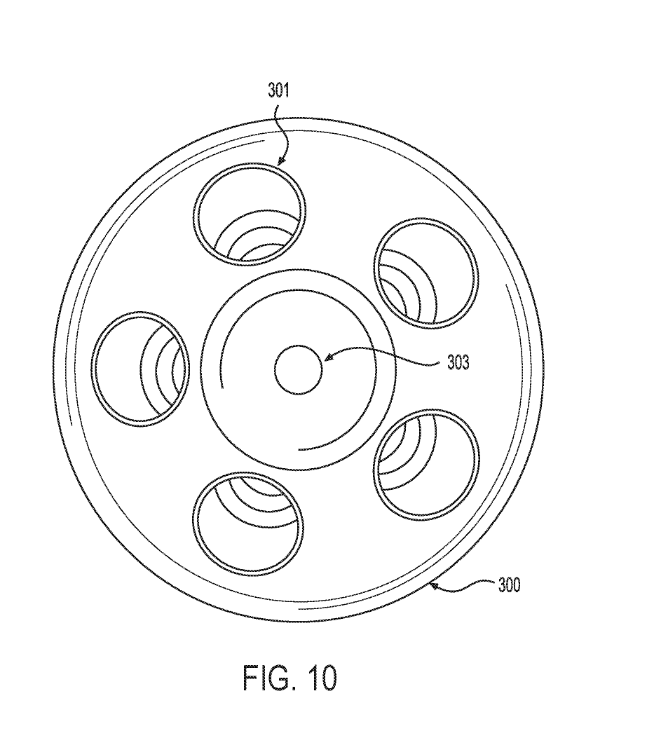

FIG. 10 is a top view of the mixing block 300. The mixing block 300 has a plurality of orifices 301 that the heat breaks (not shown) can connect to. A central orifice 303 in the mixing block 300 connects to heating elements (not shown) that can heat the multiple primary colored-filaments to create color mixing effects.

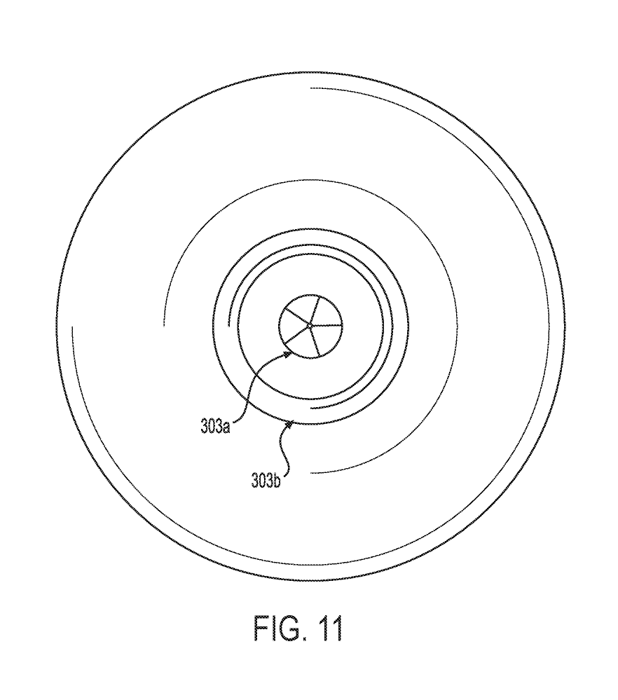

FIG. 11 is a bottom view of the mixing block 300. The male sleeve piece 303b inserts into a nozzle (not shown). The molten filament exits the mixing block 300 at the exit orifice 303a before entering the nozzle (not shown).

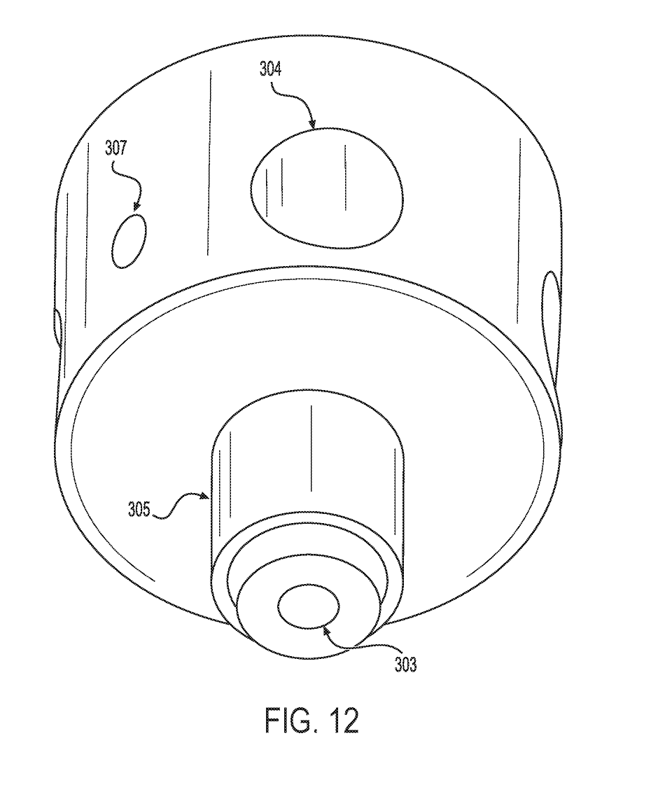

FIG. 12 is a perspective view of the mixing block 300. The male piece 305 can be inserted into the nozzle (not shown). Molten color mixed filament exits the mixing block 300 at outlet 303 to enter the nozzle (not shown). Heaters (not shown) connect to the mixing block 300 at 304 and 307 to heat the primary colored filament and allow it to mix into molten filament in the mixing block 300 (heaters not shown).

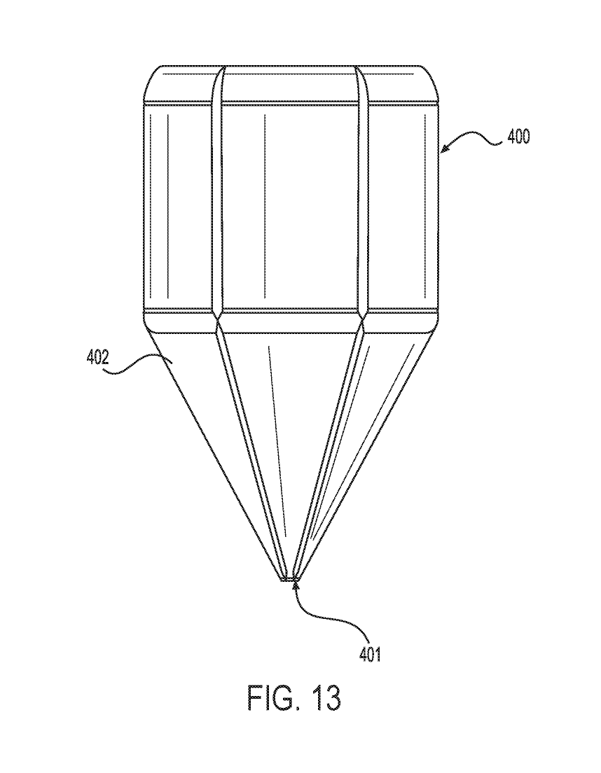

FIG. 13 is a side view of the nozzle 400. Molten filament converges via cone shape mixing point 402 and exits at outlet 401 for FDM of a three dimensional printed object.

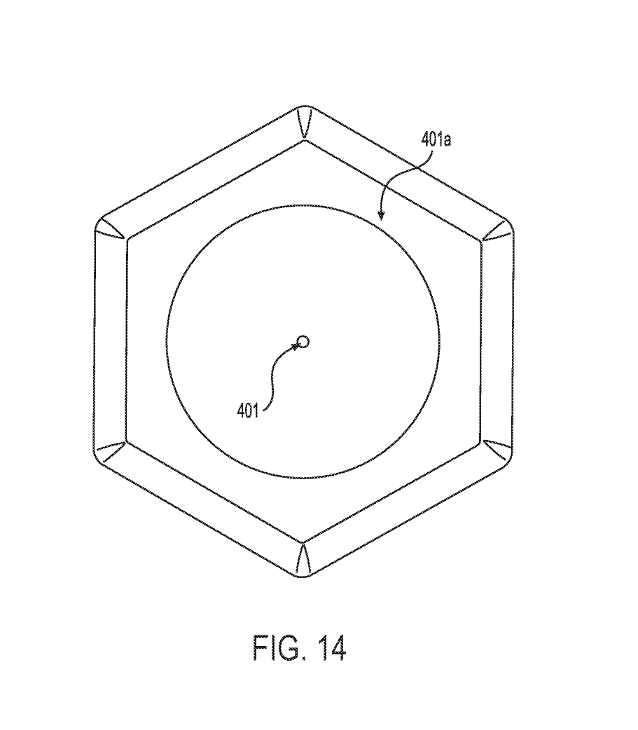

FIG. 14 is a top view of the nozzle 400. Molten filament mixes in the mixing chamber 401a of the nozzle 400 after entering from the mixing block (not shown) and exits via the outlet 401.

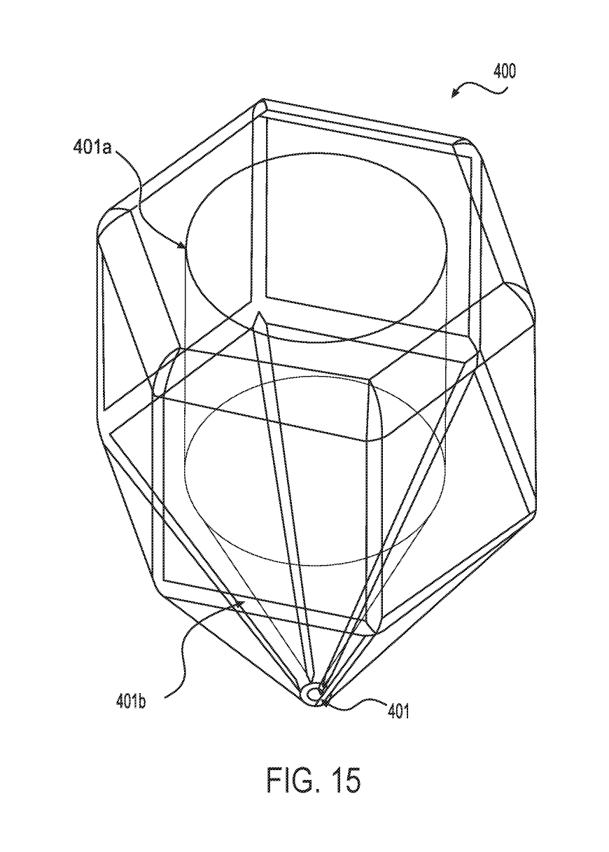

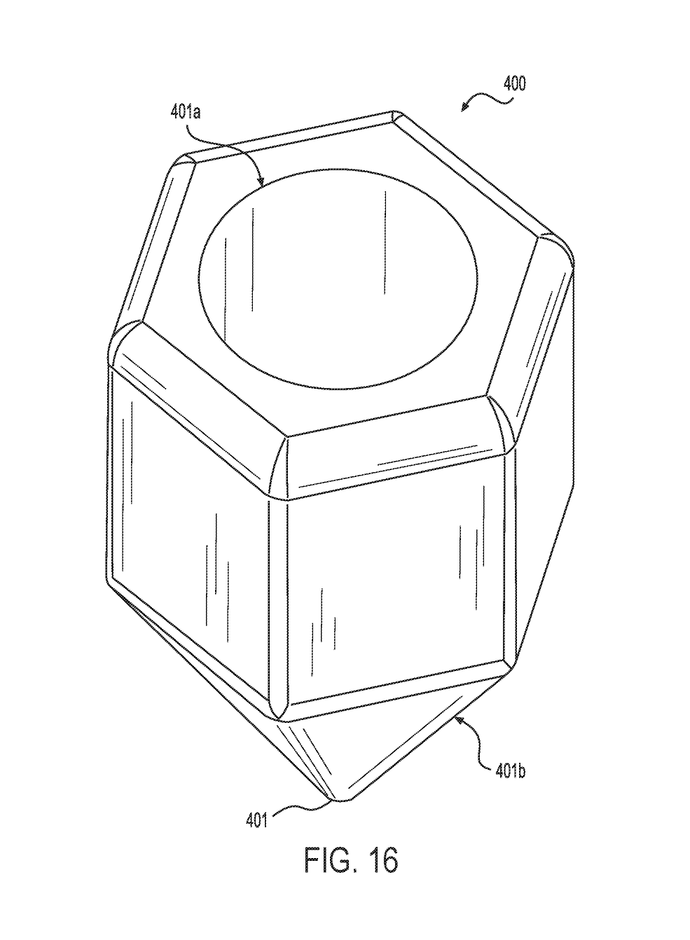

FIG. 15 is a perspective wireframe view and FIG. 16 is a perspective view of the interior mixing chamber 401b of the nozzle 400 for the nozzle assembly system for a three dimensional color printer. The molten filament enters the nozzle 400 at 401a from the mixing block (not shown) and exits the nozzle 400 at the outlet 401.

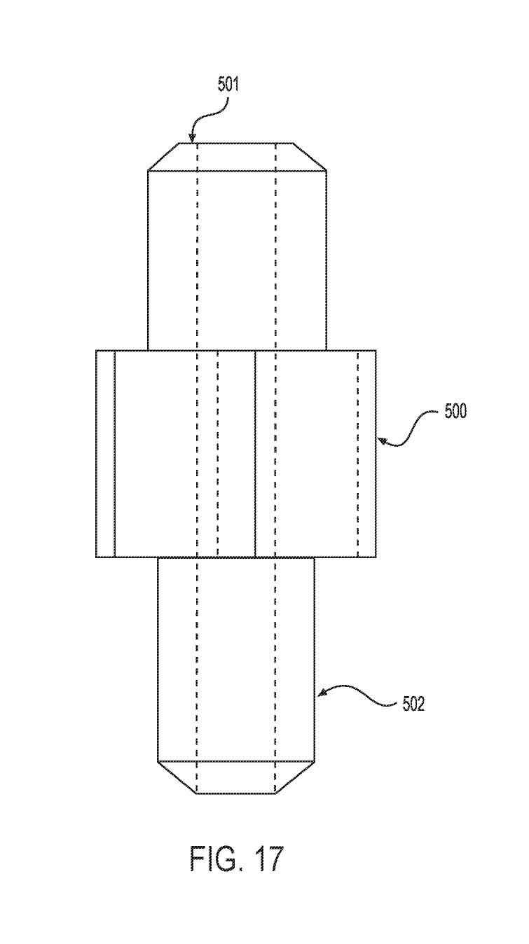

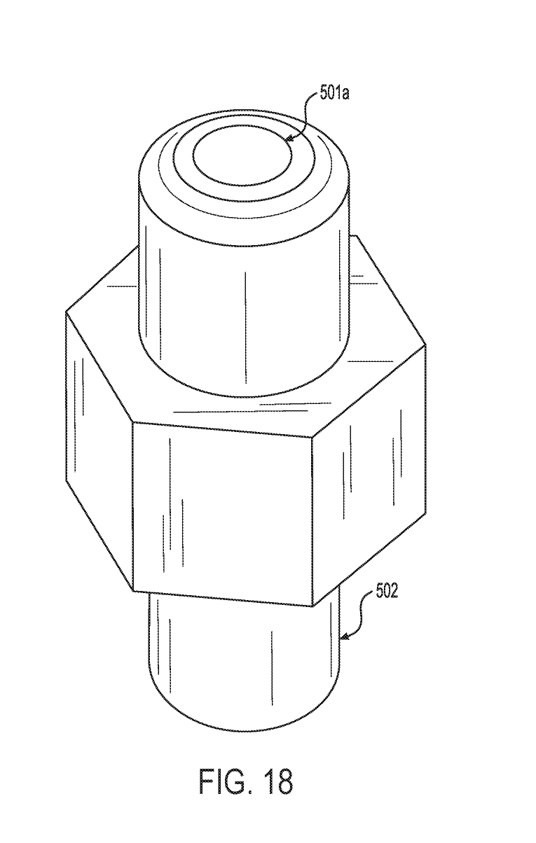

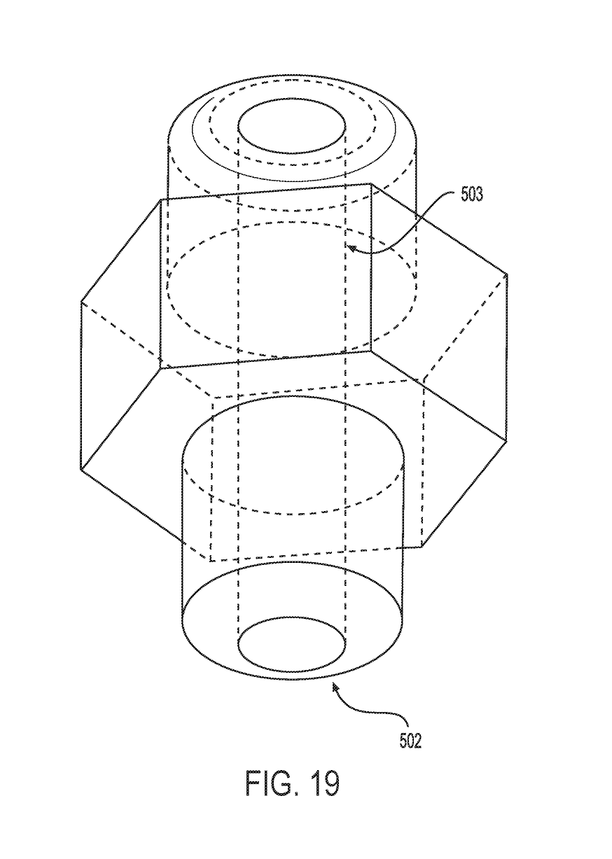

FIGS. 17-19 are fittings 500 that connect to the liquid cooling outlet of the cooling block (not shown). The fitting 500 has an inlet 501 and outlet 502 and conduit 503 that allows liquid to pass through the core of the fitting to cool the filament in the heat break (not shown) and prevent it from expanding and becoming clogged in the heat break (not shown) or any leading tubes (not shown).

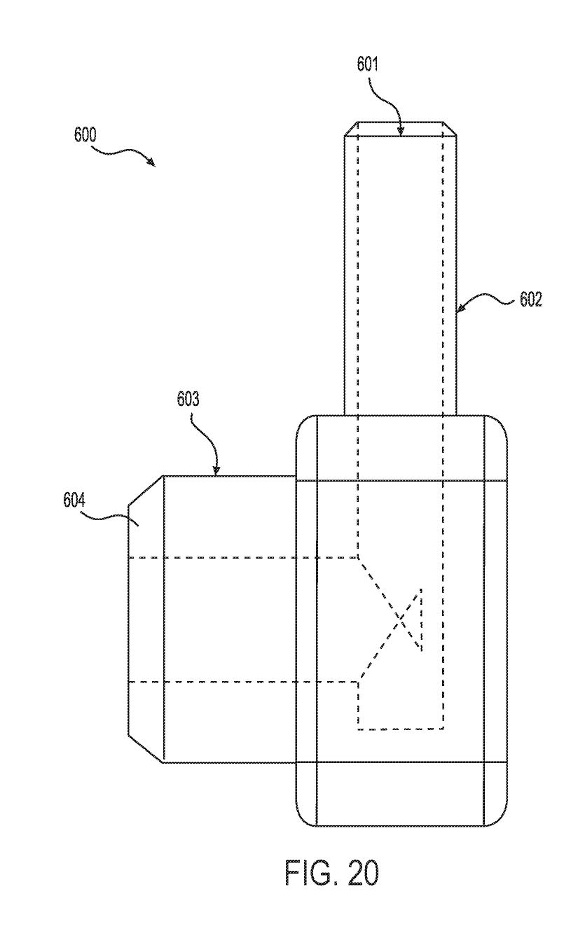

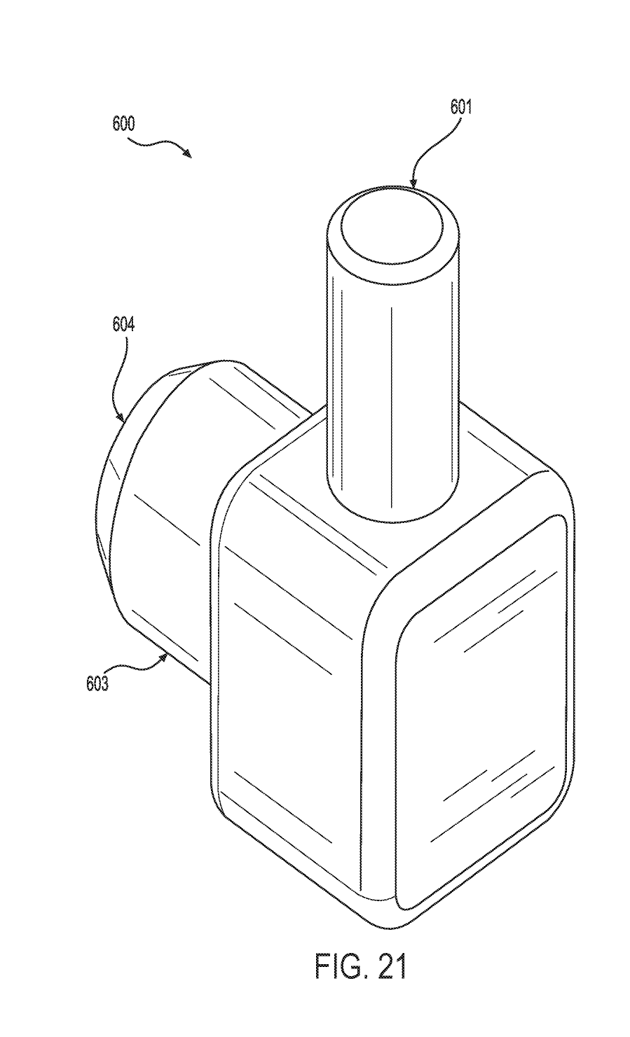

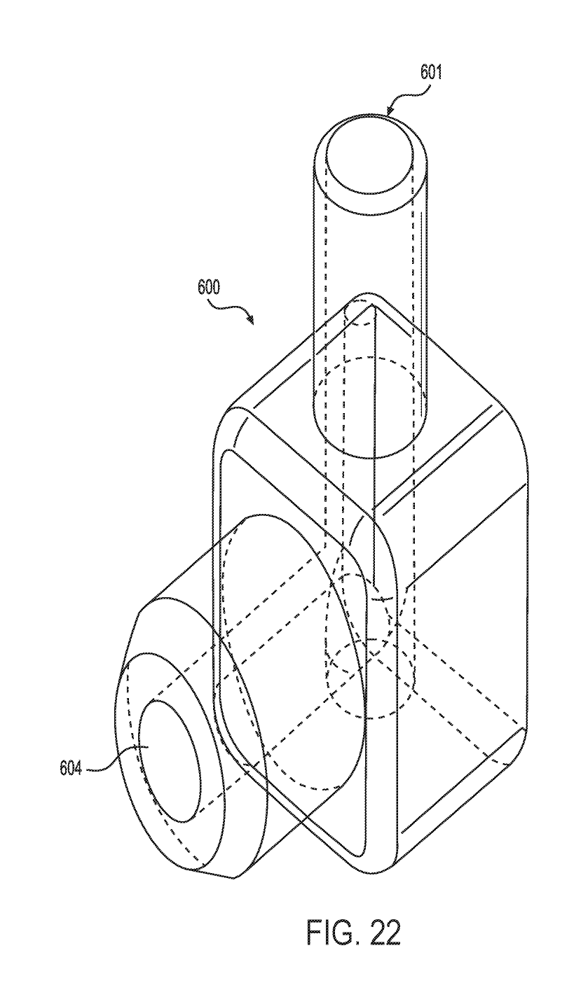

FIGS. 20-22 show fitting 600 that connects the liquid cooling system between the cooling blocks (not shown) and allows for the coolant to be pumped and cycled through the cooling blocks (not shown) to prevent the filament from expanding and creating clogs in the nozzle assembly. The fitting 600 is an L-shaped fitting in this embodiment, but may have other shapes in different embodiments depending on the sizing of the other nozzle assembly components. The fitting 600 has an inlet 601, inlet conduit 602, outlet 604 and outlet conduit 603. The fitting 600 allows for the coolant tubes to easily pass between the various cooling blocks (as seen in FIG. 1). In a preferred embodiment the coolant is water, but in other embodiments different liquids may be used.

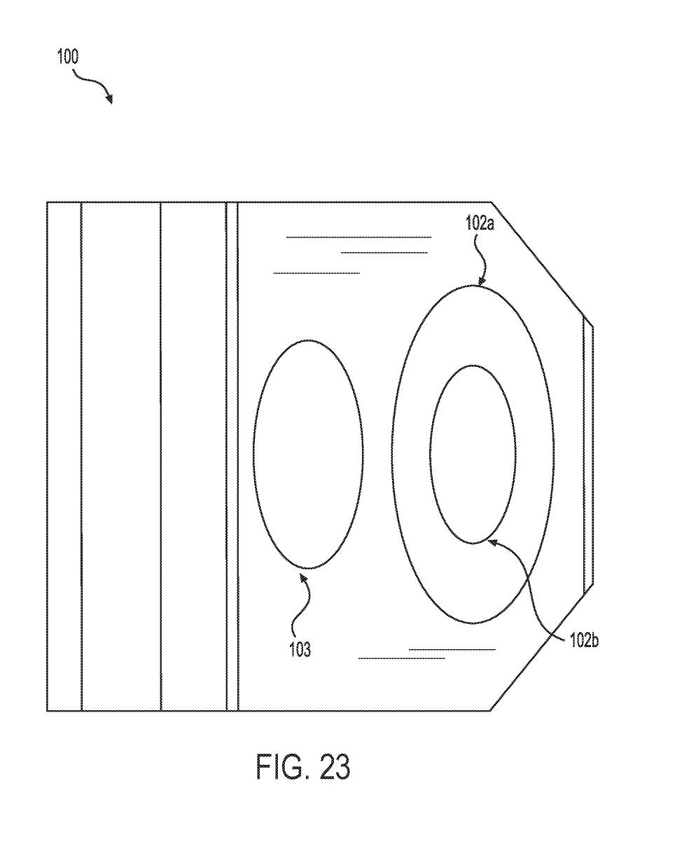

FIG. 23 is a top view of the cooling block 100. The cooling block 100 has a conduit with an inlet at 103 wherein liquid coolant can pass, a conduit 102a that fits around the heat break (not shown). The heat break has a filament conduit 102b concentric to the cooling block conduit 102a wherein the filament passes.

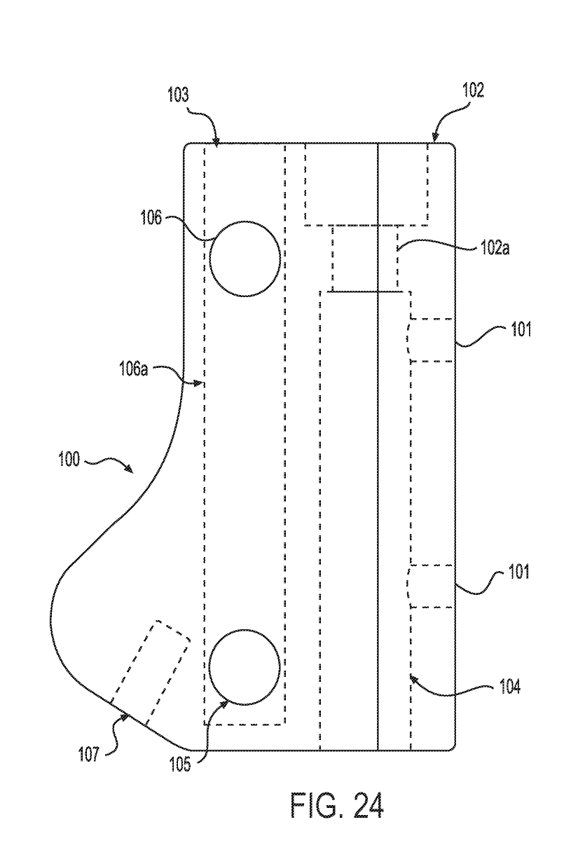

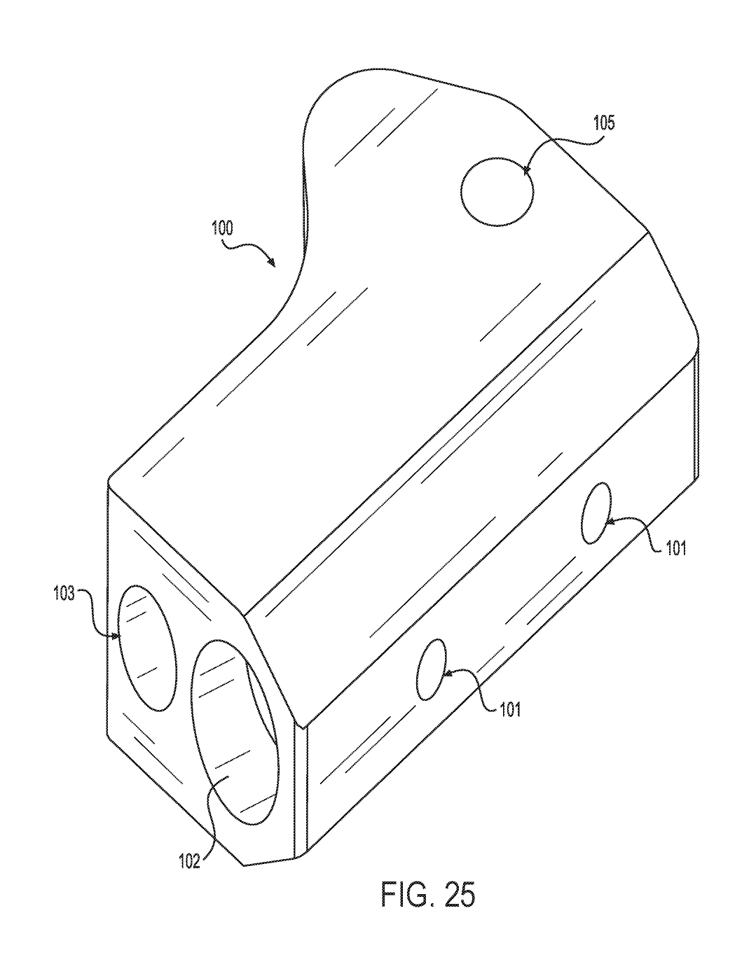

FIG. 24 is a side view of the cooling block 100 and FIG. 25 is a perspective view of the cooling block. The cooling block 100 has an inlet 102 for the filament, and has a conduit 104 that fully surrounds the heating break 102a. The cooling block 100 is held in place and connected to the heat break 102a by a pair of set screws 101. Liquid coolant passes through the conduit 106a and prevents the filament from expanding too much inside the heat break 102a and creating a clog. The liquid coolant cycles into the conduit 106a at inlets 103 and 106 and exits the cooling block 100 at the outlet 105.

Although only a few embodiments of the present invention have been described herein, it should be understand that the present invention might be embodied in many other specific forms without departing from the spirit or scope of the invention. Therefore, the present examples and embodiments are to be considered as illustrative and not restrictive, and the invention may be modified.

What is claimed:

1. A nozzle assembly for a three-dimensional printer, the nozzle assembly comprised of a mixing block with a first orifice on a top facet of the mixing block, he mixing block containing a cavity for liquefied filament to mix in, the first orifice connected to a first heat break using threads, a first cooling block that fully surrounds the first heat break, the first cooling block having a separate first conduit, through which a coolant can flow, the first conduit having an inlet and an outlet, a second orifice on the top facet of the heat block, the second orifice connected a second heat break using threads, a second cooling block that fully surrounds the second heat break, the second cooling block having a separate second conduit, through which a coolant can flow, the second conduit having an inlet and an outlet, a first channel connected to the first conduit's outlet and second conduit's inlet wherein the coolant can flow, the heat block having a bottom facet, wherein a nozzle is connected via threads to the bottom facet of the heat block, the coolant being contained in a flexible tube and pumped through the first and second cooling blocks by a pump.

2. The nozzle assembly according to claim 1, wherein the mixing block, the first and second heat break, and the first and second cooling block each have different thermal coefficient.

3. The nozzle assembly according to claim 2, wherein the mixing block is brass.

4. The nozzle assembly according to claim 2, wherein the first and second heat block are steel.

5. The nozzle assembly according to claim 2, wherein the first and second cooling blocks are aluminum.

6. The nozzle assembly according to claim 1, comprised of a third orifice connected to a third heat break using threads, a third cooling block that fully surrounds the third heat break, the third cooling block having a separate third conduit, through which a coolant can flow, the third conduit having an inlet and an outlet; a second channel connected to the second conduit's outlet and third conduit's inlet wherein the coolant can flow.

7. The nozzle assembly according to claim 6, comprised of a fourth orifice connected to a fourth heat break using threads, a fourth cooling block that fully surrounds the fourth heat break, the fourth cooling block having a separate fourth conduit, through which a coolant can flow, the fourth conduit having an inlet and an outlet, a third channel connected to the third conduit's outlet and fourth conduit's inlet wherein the coolant can flow.

8. The nozzle assembly according to claim 6, comprised of a fifth orifice connected to a fifth heat break using threads, a fifth cooling block that fully surrounds the fifth heat break, the fifth cooling block having a separate fifth conduit, through which a coolant can flow, the fifth conduit having an inlet and an outlet, a fourth channel connected to the fourth conduit's outlet and fifth conduit's inlet wherein the coolant can flow.

9. The nozzle assembly according to claim 6, comprised of a sixth orifice connected to a sixth heat break using threads, a sixth cooling block that fully surrounds the sixth heat break, the sixth cooling block having a separate sixth conduit, through which a coolant can flow, the sixth conduit having an inlet and an outlet, a fifth channel connected to the fifth conduit's outlet and sixth conduit's inlet wherein the coolant can flow.

10. The nozzle assembly according to claim 1, wherein the first cooling block each has at least one set screw connecting it to the first heat break to prevent the first cooling block from slipping off of the first heat break and the second cooling block each has at least one set screw connecting it to the second heat break to prevent the second cooling block from slipping off of the second heat break.

11. The nozzle assembly according to claim 1, wherein the coolant is water.

12. The nozzle assembly according to claim 1, wherein the coolant is in a closed loop cooling system.

13. The nozzle assembly according to claim 1, wherein each cooling block has a separate pump wherein coolant can flow.

14. A three dimensional FDM printer comprised of a nozzle assembly, the nozzle assembly comprised of a mixing block with a first orifice on a top facet of the mixing block, the mixing block containing a cavity for liquefied filament to mix in, the first orifice connected to a first heat break using threads, a first cooling block that fully surrounds the first heat break, the first cooling block having a separate first conduit, through which a coolant can flow, the first conduit having an inlet and an outlet, a second orifice on the top facet of the heat block, the second orifice connected a second heat break using threads, a second cooling block that fully surrounds the second heat break, the second cooling block having a separate second conduit, through which a coolant can flow, the second conduit having an inlet and an outlet, a first channel connected to the first conduit's outlet and second conduit's inlet wherein the coolant can flow, the heat block having a bottom facet, wherein a nozzle is connected via threads to the bottom facet of the heat block, the coolant being contained in a flexible tube and pumped through the first and second cooling blocks by a pump.

15. The three dimensional FDM printer according to claim 14, comprised of a third orifice connected to a third heat break using threads, a third cooling block that fully surrounds the third heat break, the third cooling block having a separate third conduit, through which a coolant can flow, the third conduit having an inlet and an outlet, a second channel connected to the second conduit's outlet and third conduit's inlet wherein the coolant can flow.

16. The three dimensional FDM printer according to claim 14, comprised of a fourth orifice connected to a fourth heat break using threads, a fourth cooling block that fully surrounds the fourth heat break, the fourth cooling block having a separate fourth conduit, through which a coolant can flow, the fourth conduit having an inlet and an outlet, a third channel connected to the third conduit's outlet and fourth conduit's inlet wherein the coolant can flow.

17. The three dimensional FDM printer according to claim 14, comprised of a fifth orifice connected to a fifth heat break using threads, a fifth cooling block that fully surrounds the fifth heat break, the fifth cooling block having a separate fifth conduit, through which a coolant can flow, the fifth conduit having an inlet and an outlet, a fourth channel connected to the fourth conduit's outlet and fifth conduit's inlet wherein the coolant can flow.

18. The three dimensional FDM printer according to claim 14, wherein the mixing block, the first and second heat break, and the first and second cooling block each have different thermal coefficient.

19. The three dimensional FDM printer according to claim 14, wherein the mixing block is brass.

20. The three dimensional FDM printer according to claim 14, wherein the first and second heat block are steel.
